(19) United States
(12) Patent Application Publication
(10) Pub. No.: US 2025/0361920 A1
(43) Pub. Date: Nov. 27, 2025

(54) ADAPTIVE SHOCK ABSORBER

(71) Applicant: GM GLOBAL TECHNOLOGY OPERATIONS LLC, Detroit, MI (US)

(72) Inventors: Vijaiya Ramakrishnan, Coimbatore (IN); Biju Thomas, Bengaluru (IN); Rama Potharaju, Panathur (IN)

(73) Assignee: GM GLOBAL TECHNOLOGY OPERATIONS LLC, Detroit, MI (US)

(21) Appl. No.: 18/671,587

(22) Filed: May 22, 2024

(51) Int. Cl. F16F 9/48; F16F 9/19; F16F 9/32; F16F 9/348

(52) U.S. Cl. CPC F16F 9/48; F16F 9/19; F16F 9/3214; F16F 9/3221; F16F 9/3271; F16F 9/3484; F16F 2222/12; F16F 2226/04; F16F 2228/066; F16F 2230/0064; F16F 2230/02; F16F 2230/18; F16F 2230/36

(57) ABSTRACT

Disclosed is a product that may include an active shock absorber guide rod having a guide groove formed in an outer surface thereof, wherein the guide groove has a central portion and a first slanted or spiral portion at a first end of the central portion.

The technical field generally relates to vehicle shock absorbers, compartments thereof, and methods of making and using the same.

### BACKGROUND

Passive suspension dampers are typically primary ride/handling bias tuned due to lower cost and simple damper construction requirements.

It is desirable to provide an adaptive shock absorber that can accommodate variable road conditions for a comfortable primary ride through lumps and bumps and a secondary ride through corners and potholes. Furthermore, other desirable features and characteristics of the variations disclosed herein will become apparent from the subsequent detailed description and the appended claims, taken in conjunction with the accompanying drawings and the foregoing.

### SUMMARY

A number of variations may include a product including an adaptive shock absorber guide rod having a guide groove formed in an outer surface thereof, and wherein the guide groove has a central portion and a first slanted or spiral portion at a first end of the central portion.

A number of variations may include a product wherein the guide groove includes a second slanted or spiral portion at a second end of the central portion.

A number of variations may include a product further including a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having a first valve disc set of a plurality of orifices formed therethrough, wherein the first valve disc first projection is received in the guide groove.

A number of variations may include a product further including a thrust bearing having a central through hole defined in part by a thrust bearing first inner surface having an arcuate shape and a thrust bearing second inner surface having an arcuate shape and a thrust bearing projection extending from at least one of the thrust bearing first inner surface or the thrust bearing second inner surface, the thrust bearing having a thrust bearing set of a plurality of orifices formed therethrough, wherein a portion of the guide rod is received in the central through hole formed in the thrust bearing.

A number of variations may include a product further including a second valve disc having a central through hole formed therein defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough, wherein a portion of the guide rod is received in the central through hole of the second valve disc.

A number of variations may include a product further including a piston rod having an inner surface and the first valve disc and the second valve disc being secured to the piston rod, and wherein the piston rod includes a first slot and a second slot formed therein at a first end of the piston rod, wherein the first slot has a width and height sufficient to firmly receive the second valve disc first projection and prevent the second valve disc from rotating, and wherein the second slot has a width and height sufficient to receive a portion of the first valve disc first projection and allow the first valve disc to rotate in at least one of a clockwise or counterclockwise direction, and wherein a portion of the first valve disc first projection is received in the guide groove formed in an outer surface of the guide rod.

A number of variations may include a product further including a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough, wherein a portion of the guide rod is received in the central through hole of the first valve disc.

A number of variations may include a product further including a thrust bearing having a central through hole defined in part by a thrust bearing first inner surface having an arcuate shape and a thrust bearing second inner surface having an arcuate shape and a thrust bearing first projection extending from at least one of thrust bearing first inner surface or the thrust bearing second inner surface, the thrust bearing having thrust bearing set of a plurality of orifices formed therethrough.

A number of variations may include a product further including a second valve disc having a central through hole formed therein defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough.

A number of variations may include a product further including a piston rod having an inner surface, the first valve disc, thrust bearing, and the second valve disc being secured to the piston rod, and wherein the piston rod includes a first slot and a second slot formed therein at a first end of the piston rod, wherein the first slot has a width and height sufficient to firmly receive the thrust bearing first projection and prevent the thrust bearing from rotating and to firmly receive the second valve disc first projection and prevent the second valve disc from rotating, and wherein the second slot has a width and height sufficient to receive the first valve disc first projection and allow the first valve disc to rotate in at least one of a clockwise or counterclockwise direction, and wherein the first valve disc first projection is received in the guide groove formed in an outer surface of the guide rod.

A number of variations may include a product wherein a portion of the guide rod is slidably received in the piston rod.

A number of variations may include a product wherein the guide groove includes a second slanted or spiral portion at a second end of the central portion.

A number of variations may include a product including an adaptive shock absorber including a rod having a guide groove formed in an outer surface thereof, wherein the guide groove has a central portion and a first slanted or spiral portion at a first end of the central portion; a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough, wherein the first valve disc first projection is received in the guide groove; a thrust bearing having a central through hole defined in part by a thrust bearing first inner surface having an arcuate shape and a thrust bearing second inner surface having an arcuate shape and a thrust bearing first projection extending from at least one of thrust bearing first inner surface or the thrust bearing second inner surface, the thrust bearing having thrust bearing set of a plurality of orifices formed therethrough, wherein a portion of the guide rod is received in the central through hole formed in the thrust bearing; a second valve disc having a central through hole defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough, wherein a portion of the guide rod is received in the central through hole formed in the thrust bearing; a piston rod having an inner surface and the first valve disc and the second valve disc being secured to the piston rod, and wherein the piston rod includes a first slot and a second slot formed therein at a first end of the piston rod, wherein the first slot has a width and height sufficient to firmly receive the second valve disc first projection and prevent the second valve disc from rotating, and wherein the second slot has a width and height sufficient to receive a portion of the first valve disc first projection and allow the first valve disc to rotate in at least one of a clockwise or counterclockwise direction, and wherein a portion of the first valve disc first projection is received in the guide groove formed in an outer surface of the guide rod; and wherein a portion of the guide rod is slidably received in the piston rod.

A number of variations may include a product wherein the guide groove includes a second slanted or spiral portion at a second end of the central portion.

A number of variations may include a method including providing a piston rod having an outer surface and an inner surface, the piston rod having a first slot and a second slot formed therein at a first end of the piston rod, a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough; and placing the first valve disc over the outer surface of the piston rod so that a portion of the first valve disc first projection is received in the second slot formed in the piston rod.

A number of variations may include a method further including providing a thrust bearing having a central through hole defined in part by a thrust bearing first inner surface having an arcuate shape and a thrust bearing second inner surface having an arcuate shape and a thrust bearing first projection extending from at least one of thrust valve first inner surface or the thrust second inner surface, the thrust bearing having thrust bearing set of a plurality of orifices formed therethrough; wherein the first slot has a width and height sufficient to firmly receive the thrust bearing first projection and prevent the thrust bearing from rotating; and prior to placing the first valve disc over the outer surface of the piston rod, placing the thrust bearing over the outer surface of the piston rod so that the thrust bearing first projection is received in the first slot formed in the piston rod.

A number of variations may include a method further including providing a second valve disc having a central through hole defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough; wherein the first slot has a width and height sufficient to firmly receive the second valve disc first projection and prevent the second valve disc from rotating; and prior to placing the thrust bearing over the outer surface of the piston rod, placing the second valve disc over the outer surface of the piston rod so that the thrust bearing first projection is received in the first slot formed in the piston rod.

A number of variations may include a method further including providing guide rod having a guide groove formed in an outer surface thereof, wherein the guide groove has a central portion and a first slanted or spiral portion at a first end of the central portion; and inserting at least a portion of the guide rod in the piston rod so that the guide rod slidably moves along the inner surface of the piston rod.

A number of variations may include a method wherein the inserting at least a portion of the guide rod in the piston rod is performed so that a portion of the first valve disc first projection is received in the guide groove.

A number of variations may include a method wherein the guide groove includes a second slanted or spiral portion at a second end of the central portion.

### BRIEF DESCRIPTION OF THE DRAWINGS

The variations will hereinafter be described in conjunction with the following drawing figures, wherein like numerals denote like elements, and wherein:

FIG. 1 is a sectional view of an adaptive shock absorber according to a number of variations;

FIG. 2 is an enlarged, partial, sectional view of the adaptive shock server shown in FIG. 1 according to a number of variations;

FIG. 3 is a perspective, sectional view of a portion of an adaptive shock observer according to a number of variations;

FIG. 4 is a perspective view of a guide rod for an adaptive shock observer according to a number of variations;

FIG. 5 is a perspective view of a first valve disc for an adaptive shock absorber according to a number of variations;

FIG. 6 is a perspective view of a thrust bearing for an adaptive shock absorber according to a number of variations;

FIG. 7 is a perspective view of a second valve disc for an adaptive shock absorber according to a number of variations;

FIG. 8 is a perspective view of the lock nut for an adaptive shock absorber according to a number of variations;

FIG. 9 is a partial, perspective view of a piston rod and valve subassembly for an adaptive shock absorber according to a number of variations;

FIG. 10 is a perspective, sectional of a piston rod for adaptive shock absorber according to a number of variations; and

FIG. 11 is a flow chart of a method according to a number of variations.

### DETAILED DESCRIPTION

The following detailed description is merely illustrative in nature and is not intended to limit the application and uses. Furthermore, there is no intention to be bound by any expressed or implied theory presented in the preceding technical field, background, brief summary or the following detailed description.

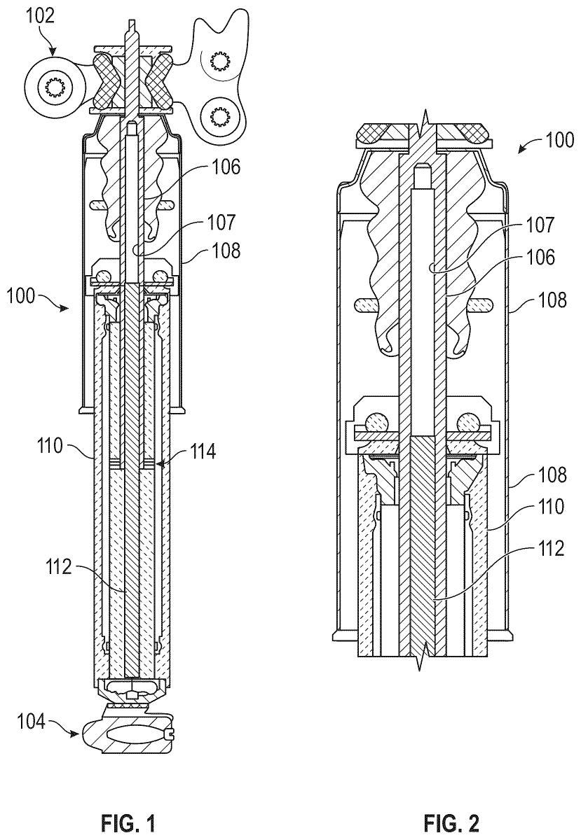

A number of variations are illustrated in FIGS. 1-2, which may include a product 100 which may be an adaptive shock absorber. The adaptive shock absorber may include a first or upper mount 102 and a second or lower mount 104, a piston rod 106 having piston rod inner surface 107 which may have a diameter. The piston rod 106 may be received in a piston rod housing 108. A guide rod 112 may be received in the piston rod 106 for slidable movement along the piston rod inner surface 107. A piston 114 may be connected to an end of the piston rod 106. The piston 114 may travel in a guide rod housing 110. Oil may be provided in the guide rod housing.

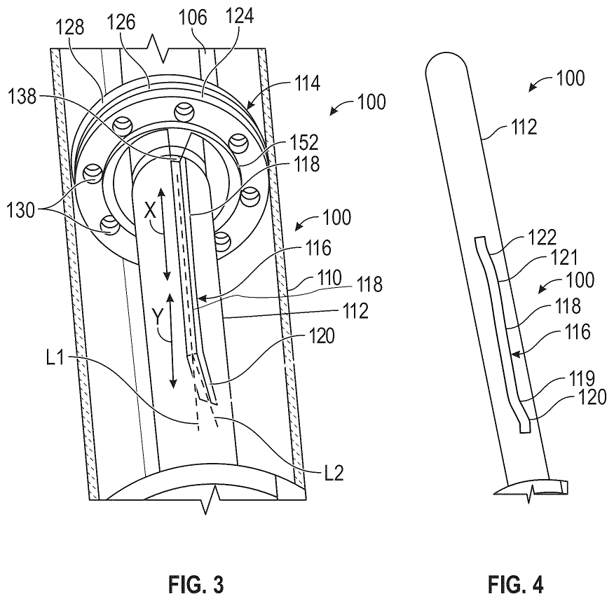

A number of variations are illustrated in FIGS. 3-4, wherein the piston 114, which may include a first valve disc 124, a thrust bearing 126, and a second valve disc 128 secured to the piston rod 106 by a lock nut 152. The first valve disc 124 may have a first set of a plurality of orifices 130 formed therethrough. The first valve disc 124 may include a first valve disc first projection 138 extending radially inward and being at least partially received in a guide groove 116 formed in an outer surface of the guide rod 112. The guide groove 116 may have a central portion 118 and a first slanted or spiral portion 120 communicating with the central portion 118 at a first end of the central portion 118 and a second slanted or spiral portion 122 communicating with the central portion 118 and a second end of the central portion 118. In a number of variations, the first slanted or spiral portion 120 may extend in a first direction away from the central portion 118 and the second slanted or spiral portion 122 may extend away from the central portion in a second direction which may be opposite of the first direction. An imaginary line L1 may extend through the central portion 118 of the guide groove 116 and may be parallel to an elongated axis of the guide rod 112. The first slanted or spiral portion 120 may have a second imaginary line L2 which may intersect at an acute angle with the first imaginary line L1 extending through the central portion 118 of the guide groove 116. The second slanted or spiral portion 122 may be formed similar to the first slanted or spiral portion 120 and may extend away from the central portion 118 in the first direction or the second direction shown in FIG. 4.

Referring again to FIG. 3, the damping is progressive in nature, with low forces during the initial suspension travel (illustrate by arrow X) to provide a better ride and during later part of the travel (illustrates by arrow Y) the forces increase to provide good stability for corners and potholes. As the vehicle is traveling and a wheel having an adaptive shock absorber connected thereto undergoes movement with a low amplitude and high frequency a sensitive damper and lower shock damping is provide as the first valve disc 124, thrust bearing 126, and first valve disc 124 travel through the area marked by arrow X and is enabled by unrestricted fluid flow through the first valve disc 124, thrust bearing 126, and first valve disc 124. As a vehicle wheel encounters pot holes, large bumps, or sharp cornering the wheel undergoes movement with a high amplitude and low frequency, a stiffer damper and higher shock damping is required, which is enabled by restricted fluid flow through first valve disc 124 as the first valve disc 124 rotates so the first valve disc set of a plurality of orifices 130 is moved out of alignment with the out of alignment with the thrust bearing set of a plurality of orifices 132 and second valve disc set of a plurality of orifices 134.

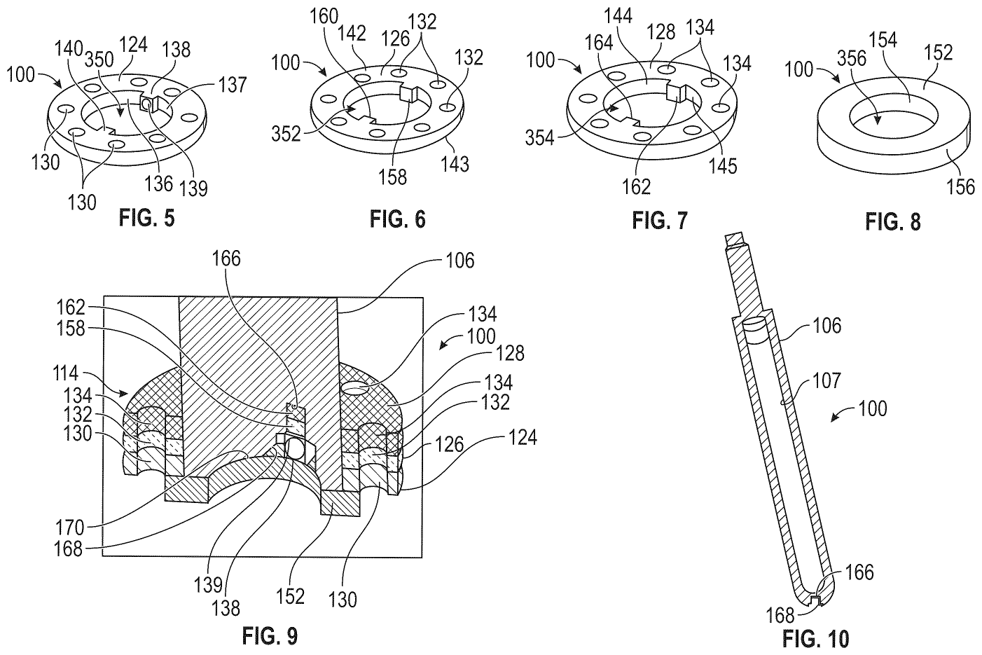

A number of variations are illustrated in FIG. 5, which may include a first valve disc 124 having a first valve disc set of a plurality of orifices 130 formed therethrough. The first valve disc 124 may have a first valve disc central through hole 350 defined in part by a first valve disc first inner surface 136 having an arcuate shape and a first valve disc second inner surface 137 having an arcuate shape. A first valve disc first projection 138 may extend radially inward from at least one of the first valve disc first inner surface 136 or first valve disc second inner surface 137. A spring loaded ball bearing 139 may be provided at an end of the first valve disc first projection 138 to facilitate assemble of the first valve disc 124 over the guide rod 112 and so that the spring loaded ball bearing 139 is forced into the guide groove formed in the guide rod 112. Alternatively, instead of a spring loaded ball bearing 139, another portion of the first valve disc first projection 138 may be spring loaded. A first valve disc second projection 140 may extend radially inward from at least one of the first valve disc first inner surface 136 or first valve disc second inner surface 137.

A number of variations are illustrated in FIG. 6, which may include a thrust bearing 126 having a thrust bearing set of a plurality of orifices 130 formed therethrough. The thrust bearing 126 may have a thrust bearing central through hole 352 formed therein defined in part by a thrust bearing first inner surface 142 having an arcuate shape and a thrust bearing second inner surface 143 having an arcuate shape, and a thrust bearing first projection 158 may extend radially inward from at least one of the thrust bearing first inner surface 142 or thrust bearing second inner surface 143. A thrust bearing second projection 160 may extend radially inward from at least one of the thrust bearing first inner surface 142 or thrust bearing second inner surface 143.

A number of variations are illustrated in FIG. 7, which may include a second valve disc 128 having a second valve disc set of a plurality of orifices 134 formed therethrough. The second valve disc 128 may have a second valve central through hole 354 defined in part by a second valve first inner surface 144 having an arcuate shape and a second valve second inner surface 145 having an arcuate shape, and a second valve disc first projection 162 may extend from at least one of the second valve first inner surface 144 or second valve second inner surface 145. A second valve disc second projection 164 may extend from at least one of the second valve first inner surface 144 or second valve second inner surface 145.

A number of variations are illustrated in FIG. 8, which may include a lock nut 152 may have a lock nut central through hole 356 defined a lock nut inner surface 154 having a diameter. The lock nut 152 may have an outer surface 156 having a diameter. The lock nut 152 may include threads (not shown) for mating with threads (not shown) on the piston rod 106.

A number of variations are illustrated in FIGS. 9-10, wherein the piston rod 106 may have at least one slot, for example, a first slot 166 and a second slot 168 formed therein at a first end 170 of the piston rod 106. The first slot 166 and the second slot 168 may communicate with each other. The first slot 166 may have a length and width to firmly receive both the thrust bearing first projection 158 and the second valve disc first projection 162 to prevent the thrust bearing 126 from rotating and prevent the second valve disc 128 from rotating, and so that the thrust bearing set of a plurality of orifices 132 and the second valve disc set of a plurality of orifices 134 are aligned. The second slot 168 may have a height and a width to receive the first valve disc first projection 138 but also sufficient wide enough to allow the first valve disc 124 to rotate. In a number of variations, the second slot 168 may be wider than the first slot 166. In a number of variations may be wider than the first slot 166 so that the first valve disc first projection 138 can move in at least one of a clockwise or counterclockwise direction away from the thrust bearing first projection 158 and the second valve disc first projection 162. When the first valve disc first projection 138 is aligned with the thrust bearing first projection 158 and with the second valve disc first projection 162 the first valve disc set of a plurality of orifices 130 are aligned with the thrust bearing set of a plurality of orifices 132 and with the second valve set of a plurality of orifices 134.

A second guide groove (not shown) may be similarly constructed on the opposite side of the guide rod 112 and may include third slot and fourth slot. A third slot may be similarly configured as the first slot 166 in the piston rod 106 and may have a height and width sufficient to firmly hold the thrust bearing second projection 160 and the second valve disc second projection 164 so that the thrust bearing 126 and the second valve disc 128 do not rotate. In a similar manner to the first valve disc first projection 138, and first valve disc second projection 140 may be received in the fourth slot (not shown) formed in the piston rod 106. The fourth slot may have a height and a width to receive the first valve disc second projection 140 but sufficient wide enough to allow the first valve disc 124 to rotate. In a number of variations, the fourth slot may be wider than the third slot. In a number of variations, the fourth slot may be wider than the third slot so that the first valve disc second projection 140 can move in at least one of a clockwise or counterclockwise direction away from the thrust bearing second projection 160 and the second valve disc second projection 164.

Referring again to FIGS. 3-4, as the first valve disc first projection 138 moves from the central portion 118 into the first slanted or spiral portion 120 of the guide groove 116 the first valve disc 124 begins to rotate, for example, in a clockwise direction so that the first valve disc set of the plurality of orifices becomes misaligned with the thrust bearing set of a plurality of orifices 132 and the second valve disc set of a plurality of orifices 134 so that the movement of the piston rod 106 begins to slow down so that the piston rod 106 does not experience a hard stop at the end of an upstroke caused by, for example but not limited to, a large bump in the road that a vehicle is traveling on. The further that the first valve disc 124 rotates the more resistance the piston rod encounters due to greater restriction of oil flow through the first valve disc set of a plurality of orifices 130. Similarly, as the first valve disc first projection 138 moves from the central portion 118 into the second slanted or spiral portion 122 of the guide groove 116 the first valve disc 124 begins to rotate, for example, in a counterclockwise direction so that the first valve disc set of the plurality of orifices 130 becomes misaligned with the thrust bearing set of a plurality of orifices 132 and the second valve disc set of a plurality of orifices 134 the movement of the piston rod 106 begins to slow down so that the piston rod 106 does not encounter a hard stop at the end of an upstroke caused by, for example but not limited to, a pot hole in the road that a vehicle is traveling on. As the first valve disc 124 rotates the piston rod 106 encounters greater restriction of oil flow through the first valve disc set of a plurality of orifices 130.

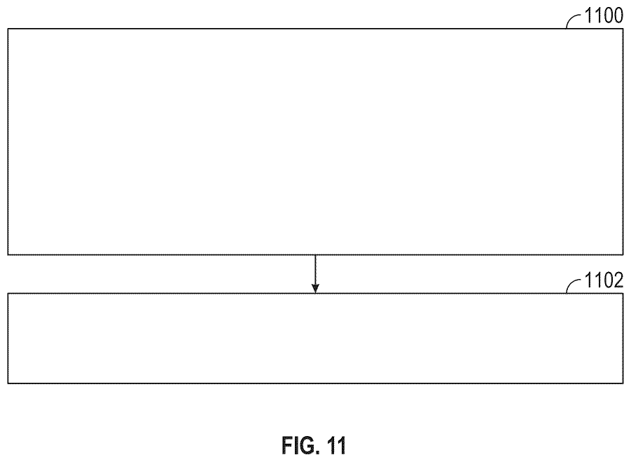

A number of variations are illustrate in FIG. 11, which may include a method including providing a piston rod having an outer surface and an inner surface, the piston rod having a first slot and a second slot formed therein at a first end of the piston rod, a first valve disc having a central through hole formed defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having a first valve disc set of a plurality of orifices formed therethrough 1100; and placing the first valve disc over the outer surface of the piston rod so that a portion of the first valve disc first projection is received in the second slot formed in the piston rod 1102.

Clause 1. A product comprising: an adaptive shock absorber guide rod having a guide groove formed in an outer surface thereof, and wherein the guide groove has a central portion and a first slanted or spiral portion at a first end of the central portion.

Clause 2. The product as set forth in clause 1 wherein the guide groove includes a second slanted or spiral portion at a second end of the central portion.

Clause 3. A product as set forth in clause 1 further comprising a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having a first valve disc set of a plurality of orifices formed therethrough, wherein the first valve disc first projection is received in the guide groove.

Clause 4. A product as set forth in clause 1 further comprising a thrust bearing having a central through hole defined in part by a thrust bearing first inner surface having an arcuate shape and a thrust bearing second inner surface having an arcuate shape and a thrust bearing projection extending from at least one of the thrust bearing first inner surface or the thrust bearing second inner surface, the thrust bearing having a thrust bearing set of a plurality of orifices formed therethrough, wherein a portion of the guide rod is received in the central through hole formed in the thrust bearing.

Clause 5. A product as set forth in clause 3 further comprising a second valve disc having a central through hole formed therein defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough, wherein a portion of the guide rod is received in the central through hole of the second valve disc.

Clause 6. A product as set forth in clause 5 further comprising a piston rod having an inner surface and the first valve disc and the second valve disc being secured to the piston rod, and wherein the piston rod includes a first slot and a second slot formed therein at a first end of the piston rod, wherein the first slot has a width and height sufficient to firmly receive the second valve disc first projection and prevent the second valve disc from rotating, and wherein the second slot has a width and height sufficient to receive a portion of the first valve disc first projection and allow the first valve disc to rotate in at least one of a clockwise or counterclockwise direction, and wherein a portion of the first valve disc first projection is received in the guide groove formed in an outer surface of the guide rod.

Clause 7. A product as set forth in clause 1 further comprising a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough, wherein a portion of the guide rod is received in the central through hole of the first valve disc.

Clause 8. A product as set forth in clause 7 further comprising a thrust bearing having a central through hole defined in part by a thrust bearing first inner surface having an arcuate shape and a thrust bearing second inner surface having an arcuate shape and a thrust bearing first projection extending from at least one of thrust bearing first inner surface or the thrust bearing second inner surface, the thrust bearing having thrust bearing set of a plurality of orifices formed therethrough.

Clause 9. A product as set forth in clause 8 further comprising a second valve disc having a central through hole formed therein defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough.

Clause 10. A product as set forth in clause 9 further comprising a piston rod having an inner surface, the first valve disc, thrust bearing, and the second valve disc being secured to the piston rod, and wherein the piston rod includes a first slot and a second slot formed therein at a first end of the piston rod, wherein the first slot has a width and height sufficient to firmly receive the thrust bearing first projection and prevent the thrust bearing from rotating and to firmly receive the second valve disc first projection and prevent the second valve disc from rotating, and wherein the second slot has a width and height sufficient to receive the first valve disc first projection and allow the first valve disc to rotate in at least one of a clockwise or counterclockwise direction, and wherein the first valve disc first projection is received in the guide groove formed in an outer surface of the guide rod.

Clause 11. The product as set forth in clause 10 wherein a portion of the guide rod is slidably received in the piston rod.

Clause 12. The product as set forth in clause 10 wherein the guide groove includes a second slanted or spiral portion at a second end of the central portion.

Clause 13. A product comprising: an adaptive shock absorber comprising a rod having a guide groove formed in an outer surface thereof, wherein the guide groove has a central portion and a first slanted or spiral portion at a first end of the central portion; a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough, wherein the first valve disc first projection is received in the guide groove; a thrust bearing having a central through hole defined in part by a thrust bearing first inner surface having an arcuate shape and a thrust bearing second inner surface having an arcuate shape and a thrust bearing first projection extending from at least one of thrust bearing first inner surface or the thrust bearing second inner surface, the thrust bearing having thrust bearing set of a plurality of orifices formed therethrough, wherein a portion of the guide rod is received in the central through hole formed in the thrust bearing; a second valve disc having a central through hole defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough, wherein a portion of the guide rod is received in the central through hole formed in the thrust bearing; a piston rod having an inner surface and the first valve disc and the second valve disc being secured to the piston rod, and wherein the piston rod includes a first slot and a second slot formed therein at a first end of the piston rod, wherein the first slot has a width and height sufficient to firmly receive the second valve disc first projection and prevent the second valve disc from rotating, and wherein the second slot has a width and height sufficient to receive a portion of the first valve disc first projection and allow the first valve disc to rotate in at least one of a clockwise or counterclockwise direction, and wherein a portion of the first valve disc first projection is received in the guide groove formed in an outer surface of the guide rod; and wherein a portion of the guide rod is slidably received in the piston rod.

Clause 14. The product as set forth in clause 13 wherein the guide groove includes a second slanted or spiral portion at a second end of the central portion.

Clause 15. A method comprising: providing a piston rod having an outer surface and an inner surface, the piston rod having a first slot and a second slot formed therein at a first end of the piston rod, a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough; and placing the first valve disc over the outer surface of the piston rod so that a portion of the first valve disc first projection is received in the second slot formed in the piston rod.

Clause 16. The method as set forth in clause 15 further comprising providing a thrust bearing having a central through hole defined in part by a thrust bearing first inner surface having an arcuate shape and a thrust bearing second inner surface having an arcuate shape and a thrust bearing first projection extending from at least one of thrust valve first inner surface or the thrust second inner surface, the thrust bearing having thrust bearing set of a plurality of orifices formed therethrough; wherein the first slot has a width and height sufficient to firmly receive the thrust bearing first projection and prevent the thrust bearing from rotating; and prior to placing the first valve disc over the outer surface of the piston rod, placing the thrust bearing over the outer surface of the piston rod so that the thrust bearing first projection is received in the first slot formed in the piston rod.

Clause 17. The method as set forth in clause 16 further comprising providing a second valve disc having a central through hole defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough; wherein the first slot has a width and height sufficient to firmly receive the second valve disc first projection and prevent the second valve disc from rotating; and prior to placing the thrust bearing over the outer surface of the piston rod, placing the second valve disc over the outer surface of the piston rod so that the thrust bearing first projection is received in the first slot formed in the piston rod.

Clause 18. The method as set forth in clause 17 further comprising providing guide rod having a guide groove formed in an outer surface thereof, wherein the guide groove has a central portion and a first slanted or spiral portion at a first end of the central portion; and inserting at least a portion of the guide rod in the piston rod so that the guide rod slidably moves along the inner surface of the piston rod.

Clause 19. The method of clause 18 wherein the inserting at least a portion of the guide rod in the piston rod is performed so that a portion of the first valve disc first projection is received in the guide groove.

Clause 20. The method as set forth in clause 19 wherein the guide groove includes a second slanted or spiral portion at a second end of the central portion.

While at least one illustrative variation has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A product comprising:
an adaptive shock absorber guide rod having a guide groove formed in an outer surface thereof, and wherein the guide groove has a central portion and a first slanted or spiral portion at a first end of the central portion.

2. The product as set forth in claim 1 wherein the guide groove includes a second slanted or spiral portion at a second end of the central portion.

3. A product as set forth in claim 1 further comprising a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having a first valve disc set of a plurality of orifices formed therethrough, wherein the first valve disc first projection is received in the guide groove.

4. A product as set forth in claim 1 further comprising a thrust bearing having a central through hole defined in part by a thrust bearing first inner surface having an arcuate shape and a thrust bearing second inner surface having an arcuate shape and a thrust bearing projection extending from at least one of the thrust bearing first inner surface or the thrust bearing second inner surface, the thrust bearing having a thrust bearing set of a plurality of orifices formed therethrough, wherein a portion of the guide rod is received in the central through hole formed in the thrust bearing.

5. A product as set forth in claim 3 further comprising a second valve disc having a central through hole formed therein defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough, wherein a portion of the guide rod is received in the central through hole of the second valve disc.

6. A product as set forth in claim 5 further comprising a piston rod having an inner surface and the first valve disc and the second valve disc being secured to the piston rod, and wherein the piston rod includes a first slot and a second slot formed therein at a first end of the piston rod, wherein the first slot has a width and height sufficient to firmly receive the second valve disc first projection and prevent the second valve disc from rotating, and wherein the second slot has a width and height sufficient to receive a portion of the first valve disc first projection and allow the first valve disc to rotate in at least one of a clockwise or counterclockwise direction, and wherein a portion of the first valve disc first projection is received in the guide groove formed in an outer surface of the guide rod.

7. A product as set forth in claim 1 further comprising a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough, wherein a portion of the guide rod is received in the central through hole of the first valve disc.

8. A product as set forth in claim 7 further comprising a thrust bearing having a central through hole defined in part by a thrust bearing first inner surface having an arcuate shape and a thrust bearing second inner surface having an arcuate shape and a thrust bearing first projection extending from at least one of thrust bearing first inner surface or the thrust bearing second inner surface, the thrust bearing having thrust bearing set of a plurality of orifices formed therethrough.

9. A product as set forth in claim 8 further comprising a second valve disc having a central through hole formed therein defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough.

10. A product as set forth in claim 9 further comprising a piston rod having an inner surface, the first valve disc, thrust bearing, and the second valve disc being secured to the piston rod, and wherein the piston rod includes a first slot and a second slot formed therein at a first end of the piston rod, wherein the first slot has a width and height sufficient to firmly receive the thrust bearing first projection and prevent the thrust bearing from rotating and to firmly receive the second valve disc first projection and prevent the second valve disc from rotating, and wherein the second slot has a width and height sufficient to receive the first valve disc first projection and allow the first valve disc to rotate in at least one of a clockwise or counterclockwise direction, and wherein the first valve disc first projection is received in the guide groove formed in an outer surface of the guide rod.

11. The product as set forth in claim 10 wherein a portion of the guide rod is slidably received in the piston rod.

12. The product as set forth in claim 10 wherein the guide groove includes a second slanted or spiral portion at a second end of the central portion.

13. A product comprising:
an adaptive shock absorber comprising a rod having a guide groove formed in an outer surface thereof, wherein the guide groove has a central portion and a first slanted or spiral portion at a first end of the central portion;
a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough, wherein the first valve disc first projection is received in the guide groove;
a thrust bearing having a central through hole defined in part by a thrust bearing first inner surface having an arcuate shape and a thrust bearing second inner surface having an arcuate shape and a thrust bearing first projection extending from at least one of thrust bearing first inner surface or the thrust bearing second inner surface, the thrust bearing having thrust bearing set of a plurality of orifices formed therethrough, wherein a portion of the guide rod is received in the central through hole formed in the thrust bearing;
a second valve disc having a central through hole defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough, wherein a portion of the guide rod is received in the central through hole formed in the thrust bearing;
a piston rod having an inner surface and the first valve disc and the second valve disc being secured to the piston rod, and wherein the piston rod includes a first slot and a second slot formed therein at a first end of the piston rod, wherein the first slot has a width and height sufficient to firmly receive the second valve disc first projection and prevent the second valve disc from rotating, and wherein the second slot has a width and height sufficient to receive a portion of the first valve disc first projection and allow the first valve disc to rotate in at least one of a clockwise or counterclockwise direction, and wherein a portion of the first valve disc first projection is received in the guide groove formed in an outer surface of the guide rod; and
wherein a portion of the guide rod is slidably received in the piston rod.

14. The product as set forth in claim 13 wherein the guide groove includes a second slanted or spiral portion at a second end of the central portion.

15. A method comprising:
providing a piston rod having an outer surface and an inner surface, the piston rod having a first slot and a second slot formed therein at a first end of the piston rod,
a first valve disc having a central through hole defined in part by a first valve disc first inner surface having an arcuate shape and a first valve disc second inner surface having an arcuate shape and a first valve disc first projection extending from at least one of the first valve disc first inner surface or the first valve disc second inner surface, the first valve disc having first valve disc set of a plurality of orifices formed therethrough; and
placing the first valve disc over the outer surface of the piston rod so that a portion of the first valve disc first projection is received in the second slot formed in the piston rod.

16. The method as set forth in claim 15 further comprising providing a thrust bearing having a central through hole defined in part by a thrust bearing first inner surface having an arcuate shape and a thrust bearing second inner surface having an arcuate shape and a thrust bearing first projection extending from at least one of thrust valve first inner surface or the thrust second inner surface, the thrust bearing having thrust bearing set of a plurality of orifices formed therethrough;
wherein the first slot has a width and height sufficient to firmly receive the thrust bearing first projection and prevent the thrust bearing from rotating; and
prior to placing the first valve disc over the outer surface of the piston rod, placing the thrust bearing over the outer surface of the piston rod so that the thrust bearing first projection is received in the first slot formed in the piston rod.

17. The method as set forth in claim 16 further comprising providing a second valve disc having a central through hole defined in part by a second valve disc first inner surface having an arcuate shape and a second valve disc second inner surface having an arcuate shape and a second valve disc first projection extending from at least one of the second valve disc first inner surface or the second valve disc second inner surface, the second valve disc having a second valve disc set of a plurality of orifices formed therethrough;
wherein the first slot has a width and height sufficient to firmly receive the second valve disc first projection and prevent the second valve disc from rotating; and
prior to placing the thrust bearing over the outer surface of the piston rod, placing the second valve disc over the outer surface of the piston rod so that the thrust bearing first projection is received in the first slot formed in the piston rod.

18. The method as set forth in claim 17 further comprising providing guide rod having a guide groove formed in an outer surface thereof, wherein the guide groove has a central portion and a first slanted or spiral portion at a first end of the central portion; and
inserting at least a portion of the guide rod in the piston rod so that the guide rod slidably moves along the inner surface of the piston rod.

19. The method of claim 18 wherein the inserting at least a portion of the guide rod in the piston rod is performed so that a portion of the first valve disc first projection is received in the guide groove.

20. The method as set forth in claim 19 wherein the guide groove includes a second slanted or spiral portion at a second end of the central portion.
